(19) United States
(12) Patent Application Publication
(10) Pub. No.: US 2023/0087580 A1
(43) Pub. Date: Mar. 23, 2023

(54) METHODS, SYSTEMS, AND COMPUTER READABLE MEDIA FOR PROVIDING DECENTRALIZED FINANCE OVER BLOCKCHAINS

(71) Applicant: Yongge Wang, Matthews, NC (US)

(72) Inventor: Yongge Wang, Matthews, NC (US)

(21) Appl. No.: 17/460,419

(22) Filed: Aug. 30, 2021

(51) Int. Cl. G06Q 20/06; G06Q 20/38; H04L 9/30

(52) U.S. Cl. CPC G06Q 20/0658; G06Q 20/381; H04L 9/3066

(57) ABSTRACT

Methods, systems, and computer readable media for providing Decentralized Finance (DeFi) are disclosed. According to one method, a method for providing digital property swap occurs at a computing platform executing a DeFi protocol, wherein the computing platform is acting as a digital property exchange center. The DeFi protocol method comprising: receiving one kind of digital property from a user; calculating an equivalent amount of another digital property; sending the said equivalent amount of the said other digital property to the said user. According to one system, a system for providing Decentralized Finance (DeFi) includes at least one computing platform, wherein the computing platform is executing a DeFi protocol and is acting as a swapping platform of the DeFi protocol. The DeFi platform is configured for: receiving digital properties as liquidity from liquidity providers; receiving one kind of digital properties from a user; and sending another kind of digital properties to the said user. The DeFi platform described herein is comprised of mathematical curves that satisfy the supply and demand principle. The main difference between the proposed DeFi protocol and known variants of DeFi systems (such as Uniswap V2) consists in the way that a liquidity provider does not need to provide both kinds of digital properties to establish a market maker. This means that a liquidity provider can establish a market by providing only one kind of digital property and establish the so-called Initial Coin Offer (ICO) process.

### U.S. PATENT DOCUMENTS

Yongge Wang. Automated Market Makers for Decentralized Finance DeFi. US Provisional Patent application U.S. 63/073,890, filed on Sep. 2, 2020.

Steven Victor Wasserman. Blockchain digital currency: systems and methods for use in enterprise blockchain banking. US patent US20180268382A1. 2018, Sep. 20

Masanobu Nishimaki. Server for supporting an exchange transaction. US patent U.S. Pat. No. 8,671,043B2. 2014

### FOREIGN PATENT DOCUMENTS

Karl Ginter, et al. Method and system for negotiating electronic contract, method and system for supporting electronic commerce, and method and system for securely managing electronic negotiation electronic commerce values chain activity, method for managing distributed electronic commerce environment, and method and system for securely managing distributed electronic commerce environment. JP2004005629A, 2003.

Coinplug Co., Ltd. System and method for trading digital virtual money having blockchain between parties. WO2016163608A1, 2015, Oct. 7.

### OTHER PUBLICATIONS

Gnosis (2019). An exchange protocol for the decentralized web, September 2019. https://github.com/gnosis/dex-research/blob/master/dFusion/dfusion.v1.pdf.

I. J. Good (1952). Rational decisions. J. Royal Statistical Society B, 14(1):107-114, 1952.

R. Hanson (2003). Combinatorial information market design. Information Systems Frontiers, 5(1):107-119, 2003.

R. Hanson (2007). Logarithmic markets coring rules for modular combinatorial information aggregation. The Journal of Prediction Markets, 1(1):3-15, 2007.

F. Martinelli and N. Mushegian (2019). A non-custodial portfolio manager, liquidity provider, and price sensor. https://balancer.finance/whitepaper/, 2019.

A. Othman, D. M. Pennock, D. M. Reeves, and T. Sandholm (2013). A practical liquidity-sensitive automated market maker. ACM Tran. Economics and Computation (TEAC), 1(3):1-25, 2013.

J. Peterson and J. Krug (2015). Augur: a decentralized, open-source platform for prediction markets. arXiv preprint arXiv:1501.01042, 2015.

Uniswap V2 (2020). Uniswap v2 core, March 2020. https://unisswap.org/whitepaper.pdf.

### CROSS-REFERENCES TO RELATED APPLICATIONS

This application is entitled to the benefit of Provisional Patent Application U.S. 63/073,890 filed on Sep. 2, 2020.

### FIELD OF THE INVENTION

The subject matter described herein relates to data processing. More specifically, the subject matter relates to methods, systems, and computer readable media for Decentralized Finance (DeFi) over blockchains.

The present invention further relates to computerised methods and systems for swapping digital properties such as cryptographic currencies over blockchains.

### BACKGROUND OF THE INVENTION

Decentralized finance (DeFi or open finance) is implemented through smart contracts (DApps) which are stored on a public distributed ledger (such as a blockchain) and can be activated to automate execution of financial instruments and digital assets. The immutable property of blockchains guarantees that these DApps are also tamper-proof and the content could be publicly audited.

DeFi applications range from automated markets (e.g., Uniswap V2 and Curve Finance), price oracles (e.g., Chainlink), to financial derivatives and many others. Most DeFi applications enable smart token transaction instantly by using price equilibrium mechanisms based on total availability supply (or called bonding curves), though still some of DeFi applications do not carry out instant transaction. For example, the Gnosis (2019) Protocol revised the traditional continuous double auction design to a discrete double auction design to address challenges with front-running. In a blockchain system, traders submit their transactions to the entire blockchain network (e.g., stored in the mempool), a miner in the system collects these transactions, validates them, and puts them into a valid block that is eventually added to an immutable chain of blocks. These submitted transactions are visible to all nodes. A malicious node (the miner itself could be malicious) may con-struct his/her own malicious transactions based on these observed transactions and insert her malicious transactions before or after the observed transactions by including appro-priate gas costs. These malicious transactions take Miner Extracted Value (MEV) profit with minimal cost. In addition to the front running attacks, it is also common to mount attacks against DeFi price oracles. In the DeFi market, a lender (a smart contract) normally queries an oracle to determine the fair market value (FMV) of borrower's collateral. The oracle could be on-chain-centralized, on-chain-decentralized, off-chain-centralized or off-chain-decentralized.

Yet another popular DeFi application is flash loan that is only valid within one blockchain transaction. Flash loan is a relatively new financial instrument and it could be vulnerable to many potential attacks. On Feb. 15, 2020, a user mounted an attack against Aave's flash loans which obtained a profit of 350K USD with a transaction fee of 132.36 USD.

Japan patent JP2004005629A to Karl Ginter et al (2003) discloses a method for secure transaction management and electronic rights protection. The international patent WO2016163608A1 to Coinplug Co. Ltd (2015) discloses a method for trading blockchain based digital virtual money using QR code. US patent US20180268382A1 to Steven Victor Wasserman (2018) discloses a method for using blockchain digital currency that is created and utilized on a permission-based network of financial institutions. This patent is also diclosed as world patent WO2018175504A1. US patent U.S. Pat. No. 8,671,043B2 is-sued to Masanobu Nishimaki (2014) disclosed a method for supporting an exchange transaction in a server.

### SUMMARY OF THE INVENTION

Methods, systems, and computer readable media for providing Decentralized Finance (DeFi) are disclosed. According to one method, a method for providing digital property swapping occurs at a computing platform executing a DeFi protocol, wherein the computing platform is acting as a platform. The DeFi protocol method comprising: receiving one kind of digital property from a user; calculating an equivalent amount of another digital property; sending the equivalent amount of the other digital property to the said user.

According to one system, a system for providing Decentralized Finance (DeFi) includes at least one computing platform, wherein the computing platform is executing a DeFi protocol and is acting as a swapping platform of the DeFI protocol. The DeFi platform is configured for: receiving digital properties as liquidity from liquidity providers; receiving one kind of digital properties from a user; and sending another kind of digital properties to the said user.

The DeFi platform described herein is comprised of mathematical curves that satisfy the supply and demand principle. The main difference between the proposed DeFi protocol and known variants of DeFi systems (such as Uniswap V2) consists in the way that a liquidity provider does not need to provide both kinds of digital properties to establish a market maker. This means that a liquidity provider can establish a market by providing only one kind of digital property and establish the so-called Initial Coin Offer (ICO) process.

The subject matter described herein can be implemented in software in combination with hardware. For example, the subject matter described herein can be implemented in software executed by a processor. In one example implementation, the subject matter described herein may be implemented using a computer readable medium having stored thereon computer executable instructions that when executed by the processor of a computer cause the computer to perform steps. Example computer readable media suitable for implementing the subject matter described herein include non-transitory devices, such as disk memory devices, chip memory devices, programmable logic devices, and application specific integrated circuits. In addition, a computer readable medium that implements the subject matter described herein may be located on a single device or computing platform or may be distributed across multiple devices or computing platforms. As used herein, each of the terms “node” and “host” refers to a physical computing platform or device including one or more processors and memory.

As used herein, the term “module” refers to hardware, firmware, or software in combination with hardware and/or firmware for implementing features described herein.

### BRIEF DESCRIPTION OF THE DRAWINGS

For a more complete understanding of the invention, reference is made to the following description and accompanying drawings, in which:

FIG. 1 is a schematic diagram illustrating the various cost function curves. This comparison contains the cost functions for LS-LMSR, constant product, constant sum, constant convex circle, and constant concave circle;

FIG. 2 is a schematic diagram illustrating a process according to an embodiment of the invention, showing steps taken for generating a private key and steps taken for generating a corresponding public key for a public key encryption scheme;

FIG. 3 is a schematic diagram illustrating how a liquidity provider deposits liquidity to an existing AMM and withdraws liquidity from an existing AMM;

FIG. 4 is a schematic diagram illustrating the cost functions for various AMMs. 410 is the cost function for the LMSR market C(x, y, z)=100 and 420 is the cost function for the LMSR market C(x, y)=100. 430 is the cost function C(x, y, z)=100 for LS-LMSR market maker 440 is the cost function C(x, y)=100 for LS-LMSR market maker. 450 is the constant product cost function xyz=100 460 is the constant product cost function xy=100. 470 is the constant mean cost function xy²z³=100 480 is the constant mean cost function x²y³=100; and

FIG. 5 is a schematic diagram illustrating the cost functions for several other AMMs and constant circle AMMs. 510 is the cost function curve for x+y+z=100 and 520 is the cost function curve for x+y=100. 530 is the cost function curve for (x−10)²+(y−10)²+(z−10)²+1.5 (xy±xz±yz)=350 540 is the cost function curve for (x−10)²+(y−10)²+1.5xy=121. 550 is the tangent line slope for LS-LMSR AMM 560 is the tangent line slope for constant product AMM. 570 is the tangent line slope for constant circle AMM.

### DETAILED DESCRIPTION

The features, structures, or characteristics of the invention described throughout this specification may be combined in any suitable manner in one or more embodiments. For example, the usage of the phrases “certain embodiments,” “some embodiments,” or other similar language, throughout this specification refers to the fact that a particular fea-ture, structure, or characteristic described in connection with the embodiment may be included in at least one embodiment of the present invention.

In the following detailed description of the illustrative embodiments, reference is made to the accompanying drawings that form a part hereof. These embodiments are described in sufficient detail to enable those skilled in the art to practice the invention, and it is understood that other embodiments may be utilized and that logical or structural changes may be made to the invention without departing from the spirit or scope of this disclosure. To avoid detail not necessary to enable those skilled in the art to practice the embodiments described herein, the description may omit certain information known to those skilled in the art. The following detailed description is, therefore, not to be taken in a limiting sense.

It is commonly believed that combined information/knowledge of all traders are incorporated into stock prices immediately. For example, these information may be used by traders to hedge risks in financial markets such as stock and commodities future markets. With aggregated information from all sources, speculators who seek to “buy low and sell high” can take profit by predicting future prices from current prices and aggregated information. Inspired by these research, the concept of “information market” was intro-duced to investigate the common principles in information aggregation. Among various approaches to information market, a prediction market is an exchange-traded market for the purpose of eliciting aggregating beliefs over an unknown future outcome of a given event. As an example, in a horse race with n horses, one may purchase a security of the form “horse A beats horse B”. This security pays off $1 if horse A beats horse B and $0 otherwise. Alternatively, one may purchase other securities such as “horse A stands at a position in S” where S is a subset of {1, . . . , n}. For the horse race event, the outcome space consists of the n! possible permutations of the n horses.

For prediction markets with a huge outcome space, the continuous double-sided auction (where the market maker keeps an order book that tracks bids and asks) may fall victim of the thin-market problem. Firstly, in order to trade, traders need to coordinate on what or when they will trade. If there are significantly less participants than the size of the outcome space, the traders may only expect substantial trading activities in a small set of assets and many assets could not find trades at all. Thus the market has a low to poor liquidity. Secondly, if a single participant knows something about an event while others know nothing about this information, this person may choose not to release this information at all or only release this information gradually. This could be justified as follows. If any release of this information (e.g., a trade based on this information) is a signal to other participants that results in belief revision discouraging trade, the person may choose not to release the information (e.g., not to make the trade at all). On the other hand, this person may also choose to leak the information into the market gradually over time to obtain a greater profit. The second challenge for the standard information market is due to the irrational participation problem where a rational participant may choose not to make any speculative trades with others (thus not to reveal his private information) after hedging his risks derived from his private information.

Logarithmic market scoring rules (LMSR) are commonly used to overcome the thin market and the irrational participation problems discussed in the preceding section. Market scoring rule based automated market makers (AMM) implicitly/explicitly maintain prices for all assets at certain prices and are willing to trade on every assets. In recent years, Hanson (2003, 2007)'s logarithmic market scoring rules (LMSR) AMM has become the de facto AMM mechanisms for prediction markets.

Let X be an independent random variable with a finite outcome space Ω. Let p be a reported probability estimate for the random variable X. That is, Σ_{ω∈Ω} p(ω)=1. In order to study rational behavior (decision) with fair fees, Good (1952) defined a reward function with the logarithmic market scoring rule (LMSR) as follows:

{s_{ω}(p)=bIn(2·p(ω))} (1)

where b>0 is a constant. A participant in the market may choose to change the current probability estimate p₁ to a new estimate p₂. This participant will be rewarded s_{ω}(p₂)— s_{ω}(p₁) if the outcome w happens. Thus the participant would like to maximize his expected value (profit)

$$\begin{matrix}S ( {p}_{1} , {p}_{2} ) = {\sum }_{ω ∈ Ω} {p}_{2} ( ω ) ( {s}_{ω} ( {p}_{2} ) - {s}_{ω} ( {p}_{1} ) ) \\ = b {\sum }_{ω ∈ Ω} {p}_{2} ( ω ) ln \frac{{p}_{2} ( ω )}{{p}_{1} ( ω )} = b D ( {p}_{2} \vert \vert {p}_{1} )\end{matrix} \qquad ( 2 )$$

by honestly reporting his believed probability estimate, where D (p₂∥ p₁) is the relative entropy or Kullback Leibler distance between the two probabilities p₂ and p₁. An LMSR market can be considered as a sequence of logarithmic scoring rules where the market maker (that is, the patron) pays the last participant and receives payment from the first participant.

Equivalently, an LMSR market can be interpreted as a market maker offering |Ω| securities where each security corresponds to an outcome and pays $1 if the outcome is realized in Hanson (2003). In particular, changing the market probability of ω ∈ Ω to a value p(ω) is equivalent to buying the security for ω until the market price of the security reaches p(ω). As an example for the decentralized financial (DeFi) AMM on blockchains, assume that the market maker offers n categories of tokens. Let q=(q₁, . . . , gₙ) where q₁ represents the number of outstanding tokens for the token category i. The market maker keeps track of the cost function

$$C ( q ) = b ln {\sum }_{i = 1}^{n} {e}^{{q}_{i} / b} \qquad ( 3 )$$

and a price function for each token

$${P}_{i} ( q ) = \frac{\partial C ( q )}{\partial {q}_{i}} = \frac{{e}^{{q}_{i} / b}}{{Σ}_{j = 1}^{n} {e}^{{q}_{j} / b}} \qquad ( 4 )$$

It should be noted that the equation (4) is a generalized inverse of the scoring rule function (1). The cost function captures the amount of total assets wagered in the market where C(q₀) is the market maker's maximum subsidy to the market. The price function Pᵢ(g) gives the current cost of buying an infinitely small quantity of the category i token. If a trader wants to change the number of outstanding shares from q₁ to q₂, the trader needs to pay the cost difference C(q₂)−C(q₂). LMSR AMMs have been implemented in Augur (see, Peterson and Krug 2015) and Gnosis (2019).

Next we use an example to show how to design AMMs using LMSR. Assume that b=1 and the patron sets up an automated market marker q₀=(1000, 1000) by depositing 1000 coins of token A and 1000 coins of token B. The initial market cost is C(q₀)=ln(e¹⁰⁰⁰+e¹⁰⁰⁰)=1000.693147. The instantaneous prices for a coin of tokens are

$${P}_{A} ( {q}_{0} ) = \frac{{e}^{1000}}{{e}^{1000} + {e}^{1000}} = 0.5 and {P}_{B} ( {q}_{0} ) = \frac{{e}^{1000}}{{e}^{1000} + {e}^{1000}} = 0.5$$

If this AMM is used as a price oracle, then one coin of token A equals

$$\frac{{P}_{A} ( {q}_{0} )}{{P}_{B} ( {q}_{0} )} = 1$$

coin of token B. If a trader uses 0.689772 coins of token B to buy 5 coins of token A from market g₀, then the market moves to a state q₁=(995, 1000.689772) with a total market cost C (q₁)=1000.693147=C(q₀). The instantaneous prices for a coin of tokens in q₁ are P_{A}(q₁)=0.003368975243 and P_{B}(q₁)=295.8261646. Now a trader can use 0.0033698 coins of token B to purchase 995 coins of token A from the AMM q₁ with a resulting market maker state q₂=(0, 1000.693147) and a total market cost C (q₂)=1000.693147=C(q₀). The instantaneous prices for a coin of tokens in market maker q₂ are P_{A}(q₂)=2.537979907×10⁻⁴³⁵ and P_{B}(q₂)=1.

The above example shows that LMSR based AMM works well only when the outstanding shares of the tokens are evenly distributed (that is, close to 50/50). When the outstanding shares of the tokens are not evenly distributed, a trader can purchase all coins of the token with lesser outstanding shares and let the price ratio

$$\frac{{P}_{A} ( q )}{{P}_{B} ( q )}$$

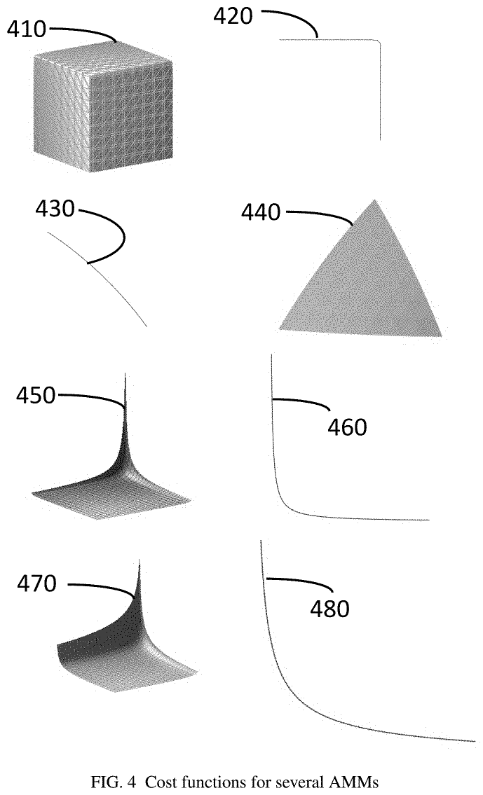

changes to an arbitrary value with a negligible cost. This observation is further justified by the LMSR cost function curves in FIG. 4. The plot 410 of FIG. 4 is for the cost function C(x, y, z)=100 with three tokens and the plot 420 of FIG. 4 is for the cost function C (x, y)=100 with two tokens. The plot 420 shows that the price for each token fluctuates smoothly only in a tiny part (the upper-right corner) of the curve with evenly distributed token shares. Outside of this part, the tangent line becomes vertical or horizontal. That is, one can use a tiny amount of one token to purchase all outstanding coins of the other token in the market maker. In a conclusion, LMSR based AMMs may not be a good solution for DeFi applications.

In the traditional prediction market, the three desired properties for a pricing rule to have include: path independence, translation invariance, and liquidity sensitivity. Path independence means that if the market moves from one state to another state, the payment/-cost is independent of the paths that it moves. For example, this means that a trader cannot place a series of transactions and profit without assuming some risk. Translation invariance requires that the cost of buying a guaranteed payout of x always costs x. Liquid sensitivity means that a fixed-size investment moves prices less in thick (liquid) markets than in thin (illiquid) markets. (see, e.g., Othman et al 2013) For a pricing rule P,
1. P is path independent if the value of line integral (cost) between any two quantity vectors depends only on those quantity vectors, and not on the path between them.
2. P is translation invariant if ΣᵢPᵢ (q)=1 for all valid market state q.
3. P is liquidity insensitive if Pᵢ(q+(α, . . . , α))=Pᵢ(q) for all valid market state q and α.

Othman et al (2013) showed that no market maker can satisfy all three of the desired properties at the same time. Furthermore, Othman et al (2013) showed that LMSR satisfies translation invariance and path independence though not liquidity sensitivity. Then, by relaxing the translation invariance, Othman et al (2013) proposed the Liquidity-Sensitive LMSR market. In particular, LS-LMSR changes the constant b in the LMSR formulas to b(q)=αΣᵢqᵢ where a is a constant and requiring the cost function to always move forward in obligation space. Specifically, for q=(q₁, . . . , qₙ), the market maker keeps track of the cost function

$$C ( q ) = b ( q ) ln {\sum }_{i = 1}^{n} {e}^{{q}_{i} / b ( q )} \qquad ( 5 )$$

and a price function for each token

$${P}_{i} ( q ) = α ln ( {\sum }_{j = 1}^{n} {e}^{{q}_{j} / b ( q )} ) + \frac{{e}^{{q}_{i} / b ( q )} {Σ}_{j = 1}^{n} {q}_{j} - {Σ}_{j = 1}^{n} {q}_{j} {e}^{{q}_{j} / b ( q )}}{{Σ}_{j = 1}^{n} {q}_{j} {Σ}_{j = 1}^{n} {e}^{{q}_{j} / b ( q )}} \qquad ( 6 )$$

Furthermore, in order to always move forward in obligation space, we need to revise the cost that a trader should pay. In the proposed “no selling” approach, assume that the market is at state q₁ and the trader tries to impose an obligation q_{δ}=(q′₁, . . . , g′ₙ) to the market with q̅_{δ}=minᵢ q′ⁱ<0. That is, the trader puts q′ⁱ coins of token i to the market if q′ᵢ≥0 and receives −q′ᵢ coins of token i from the market if q′ᵢ<0. Let q̅_{δ}=(−q̅_{δ}, . . . , −q̅_{δ}). Then the trader should pay

C(q+q_{δ}+q̅_{δ})+q̅_{δ}−C(q) (7)

and the market moves to the new state q+q_{δ}+q̅_{δ}. In the proposed “covered short selling approach”, the market moves in the same way as LMSR market except that if the resulting market q′ contains a negative component, then the market q′ automatically adds a constant vector to itself so that all components are non-negative. In either of the above proposed approach, if q+q_{δ} contains negative components, extra shares are automatically mined and added to the market to avoid negative outstanding shares. This should be avoided in DeFi applications. In DeFi applications, one should require that q_{δ} could be imposed to a market q₀ only if there is no negative component in q+q_{δ} and the resulting market state is q+q_{δ}. LS-LMSR is obviously path independent since it has a cost function. Othman et al (2013) showed that LS-LMSR has the desired liquidity sensitive property. Plot 430 of FIG. 4 displays the curve of the cost function C(x, y, z)=100 for LS-LMSR market maker with three tokens and Plot 440 of FIG. 4 displays the curve of the cost function C (x, y)=100 for LS-LMSR market maker with two tokens. It is clear that these two curves are concave.

Constant product market makers have been used in DeFi applications (e.g., Uniswap V2) to enable on-chain exchanges of digital assets and on-chain-decentralized price oracles. In this market, one keeps track of the cost function C(q)=Πᵢ₌₁ⁿ qᵢ as a constant. For this market, the price function for each token is defined as

$${P}_{i} ( q ) = \frac{\partial C ( q )}{\partial {q}_{i}} = {\prod }_{j \neq i} {q}_{j} .$$

Plot 450 of FIG. 4 shows the curve of the constant product cost function xy z=100 with three tokens and plot 460 of FIG. 4 shows the curve of the constant product cost function xy=100 with two tokens. It is clear that the constant product cost function is convex which conforms to the principle of supply and demand.

The cost function C(q)=Πᵢ₌₁ⁿ qᵢ^{w}^{ᵢ} has been used to design constant mean AMMs (see, Martinelli and Mushegian 2019) where w_{z} are positive real numbers. In the constant mean market, the price function for each token is

$${P}_{i} ( q ) = \frac{\partial C ( q )}{\partial {q}_{i}} = {w}_{i} {q}_{i}^{{w}_{i} - 1} {\prod }_{j \neq i} {q}_{j} .$$

Plot 470 of FIG. 4 shows the curve of the constant mean cost function xy²z³=100 with three tokens and plot 480 of FIG. 4 shows the curve of the constant mean cost function x²y³=100 with two tokens. It is clear that the constant mean cost function is a convex function.

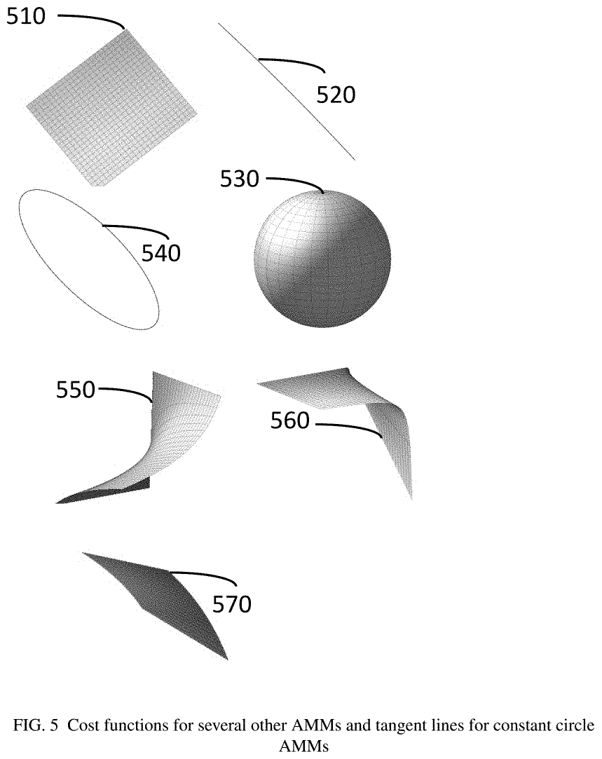

One may also use the cost function C (q)=Σᵢ₌₁ⁿ qᵢ to design constant sum market makers. In this market, the price for each token is always 1. That is, one coin of a given token can be used to trade for one coin of another token at any time when supply lasts. Plot 510 of FIG. 5 shows the curve of the constant sum cost function x+y z=100 with three tokens and plot 520 of FIG. 5 shows the curve of the constant sum cost function x+y=100 with two tokens.

It is straightforward to check that constant product/mean/sum AMMs achieve path independence but not translation invariance. Furthermore, constant product/mean AMMs are liquidity sensitive and constant sum AMM is liquidity insensitive.

The previous paragraphs compare the advantages and disadvantages of LMSR, LS-LMSR, and constant product/mean/sum AMMs. The analysis shows that none of them is ideal for DeFi applications. In this section, we propose AMMs based on constant ellipse/circle cost functions. That is, the AMM's cost function is defined by

$$C ( q ) = {\sum }_{i = 1}^{n} {( {q}_{i} - a )}^{2} + b {\sum }_{i \neq j} {q}_{i} {q}_{j} \qquad ( 8 )$$

where a, b are constants. In constant ellipse/circle AMMs, the price function for each token is

$${P}_{i} ( q ) = \frac{\partial C ( q )}{\partial {q}_{i}} = 2 ( {q}_{i} - a ) + b {\sum }_{j \neq i} {q}_{j} .$$

For AMMs, we only use the first quadrant of the coordinate plane. By adjusting the parameters a, b in the equation (8), one may keep the cost function to be concave (that is, using the upper-left part of the ellipse/circle) or to be convex (that is, using the lower-left part of the ellipse/circle). By adjusting the absolute value of a, one may obtain various price amplitude and price fluctuation rates based on the principle of supply and demand for tokens. It is observed that constant ellipse/circle AMM price functions are liquidity sensitive and path independent but not translation invariance.

Plot 530 of FIG. 5 shows the curve of the constant ellipse cost function

(x−10)²+(y−10)²+(z−10)²+1.5(xy+xz+yz)=350

with three tokens and Plot 540 of FIG. 5 shows the curve of the the constant ellipse cost function

(x−10)²+(y−10)²+1.5xy=121

with two tokens. As mentioned in the preceding paragraphs, one may use convex or concave part of the ellipse for the cost function. For example, in the second plot of Figure ??, one may use the lower-left part in the first quadrant as a convex cost function or use the upper-right part in the first quadrant as a concave cost function.

Supply and demand, coin liquidity, and token price fluctuation. Without loss of generality, this section considers AMMs consisting of two tokens: a USDT token where each USDT coin costs one US dollar and an imagined spade suit token [symbol] . The current market price of a [symbol] token coin could have different values such as half a USDT coin, one USDT coin, two USDT coins, or others. In Decentralized Finance (DeFi) applications, the patron needs to provide liquidity by depositing coins of both tokens in the AMM. Without loss of generality, we assume that, at the time when the AMM is incorporated, the market price for a coin of spade suit token is equivalent to one USDT coin. For general cases that the market price for one [symbol] coin is not equivalent to one USDT coin at the time when the market maker is incorporated, we can create virtual shares in the AMM by dividing or merging actual coins. That is, each share of USDT (respectively [symbol] ) in the AMM consists of a multiple or a portion of USDT (respectively [symbol] ) coins.

To simplify our notations, we will use q=(x, y) instead of q=(q₁, q₂) to represent the market state. In this section, we will only study the price fluctuation of the first token based on the principle of supply and demand and the trend of the price ratio

$$\frac{{P}_{x} ( q )}{{P}_{y} ( q )} .$$

By symmetry or the cost functions, the price fluctuation of the second token and the ratio

$$\frac{{P}_{y} ( q )}{{P}_{x} ( q )}$$

have the same property. In the following, we analyze the token price fluctuation for various AMM models with the initial market state q₀=(1000, 1000). That is, the patron creates the AMM by depositing 1000 USDT coins and 1000 spade suit coins in the market. The analysis results are summarized in the following Table.

| AMM type | market cost | Pₓ(q)/P_{y}(q) | $tangent \frac{\partial y}{\partial x}$ |
|---|---|---|---|
| LS-LMSR | 2386.29436 | (0.648, 1.543) | (−1.543, −0.648) |
| cons. product | 1000000 | (0, ∞) | (−∞, 0) |
| cons. sum | 2000 | 1 | −1 |
| cons. circle | 50000000 | (0.624, 1.604) | (−1.604, −0.624) |

For the LS-LMSR based AMM, the market cost is

C(q₀)=2000·ln(e^{1000/2000}+e^{1000/2000})=2386.294362.

At market state q₀, the instantaneous prices for a coin of tokens are Pₓ(q₀)=P_{y}(q₀)=1.193147181. A trader may use 817.07452949 spade suit coins to purchase 1000 USDT coins with a resulting market state q₁=(0, 1817.07452949) and a resulting market cost C(q₁)=2386.294362. At market state q₁, the instantaneous prices for a coin of tokens are Pₓ(q₁)=0.8511445298 and P_{y}(q₁)=1.313261687. Thus we have Pₓ(q₁)/P_{y}(q₁)=0.6481149479. The tangent line slope of the cost function curve indicates the token price fluctuation stability in the automated market. The tangent line slope for the LS-LMSR cost function curve at the market state q=(x, y) is

$$\frac{\partial y}{\partial x} = - \frac{( x + y ) ( {e}^{\frac{x}{x + y}} + {e}^{\frac{y}{x + y}} ) ln ( {e}^{\frac{x}{x + y}} + {e}^{\frac{y}{x + y}} ) + y ( {e}^{\frac{x}{x + y}} - {e}^{\frac{y}{x + y}} )}{( x + y ) ( {e}^{\frac{x}{x + y}} + {e}^{\frac{y}{x + y}} ) ln ( {e}^{\frac{x}{x + y}} + {e}^{\frac{y}{x + y}} ) + x ( {e}^{\frac{y}{x + y}} - {e}^{\frac{x}{x + y}} )} .$$

For the LS-LMSR AMM with an initial state q₀=(1000, 1000), the tangent line slope (plot 550 of FIG. 5) changes smoothly and stays between −1.542936177 and −0.6481149479. Thus the token price fluctuation is quite smooth. By the principle of supply and demand, it is expected that when the token supply increases, the token price decreases. That is, the cost function curve should be convex. However, the cost function curve for LS-LMSR market is concave. This can be considered as a disadvantage of LS-LMSR markets for certain DeFi applications. Though LS-LMSR does not satisfy the translation invariance property, it is shown in Othman, et al (2013) that the sum of prices are bounded by 1+αnlnn. For the two token market with α=1, the sum of prices are bounded by 1+2ln2=2.386294362 and this value is achieved when x=y.

For the constant product AMM, the market cost is C(q₀)=1000000 and the constant product cost function is x·y=1000000. At market state q₀, the instantaneous token prices are Pₓ(q₀)=P_{y}(q₀)=1000. Thus we have

$$\frac{{P}_{x} ( q )}{{P}_{y} ( q )} = 1 .$$

A trader may use one USDT coin to buy approximately one coin of spade suit token and vice versa at the market state q₀. However, as market state moves on, the prices could change dramatically based on token supply in the market and the pool of a specific coin will never run out. Specifically, at market state q₀, a trader may spend 10 USDT coins to purchase 9.900990099 spade suit coins. On the other hand, a user may spend 500 USDT coins to purchase only 333.3333333 coins of spade suit token from the market state q₀ with a resulting market state q₁=(1500, 666.6666667). Note that in the example of LS-LMSR market example, at market state q₀, a trader can spend 500 USDT coins to purchase 559.926783 coins of spade suit. Furthermore, in the market state q₁, one USDT coin could purchase 0.4444444445 coins of spade suit token. The tangent line slope of the cost function curve at the market state q=(x, y) is

$$\frac{\partial y}{\partial x} = - \frac{{P}_{x} ( q )}{{P}_{y} ( q )} = - \frac{y}{x} .$$

That is, the tangent line slope for the cost function curve (plot 550 of FIG. 5) can go from −∞ to 0 and the token price fluctuation could be very sharp. Specifically, if the total cost of the initial market q₀ is “small” (compared against attacker's capability), then a trader/attacker could easily control and manipulate the market price of each coins in the AMM. In other words, this kind of market maker may not serve as a reliable price oracle. A good aspect of the constant product cost function is that the curve is convex. Thus when the token supply increases, the token price decreases. On the other hand, the sum of prices Pₓ(q)+P_{y} (q)=x+y in constant product market is unbounded. Thus constant production cost function could not be used in prediction markets since it leaves a chance for a market maker to derive unlimited profit from transacting with traders.

For constant sum AMMs, the market cost is C(q₀)=2000 and the constant sum cost function is x+y=2000. A trader can always use one USDT coin to buy one spade suit token coin in the market and vice versa. This price is fixed and will not change as long as token supply lasts in the market. For example, a trader may spend 1000 USDT coins to purchase 1000 spade suit coins with a resulting market state q₁=(2000, 0). At the market state q₁, no one can purchase spade suit coins any more until someone spends some spade suit coins to purchase USDT coins from this market.

As we have mentioned in the preceding Sections, one may use the upper-right part of the curve for a concave cost function or use the lower-left part of the curve for a convex cost function. In order to conform to the principle of supply and demand, we analyze the convex cost functions based on constant circle/ellipse. Constant circle and constant ellipse share many similar properties though they have different characteristics. By adjusting corresponding parameters, one may obtain different cost function curves with different properties (e.g., different price fluctuation range, different tangent line slope range, etc). The approaches for analyzing these cost function curves are similar. Our following analysis uses the low-left convex part of the circle (x−6000)²+(y−6000)²=2×5000² as the constant cost function.

For AMMs based on this cost function C (q)=(x−6000)²+(y−6000)², the market cost is C(q₀)=50000000. At market state q₀, the instantaneous prices for a coin of tokens are Pₓ(q₀)=P_{y} (q₀)=−10000. A trader may use 1258.342613 spade suit coins to purchase 1000 USDT coins with a resulting market state q₁=(0, 2258.342613) and a resulting market cost C(q₁)=C(q₀). At market state q₁, the instantaneous prices for a coin of tokens are Pₓ (q₁)=12000 and P_{y}(q₁)=7483.314774. Thus we have

$$\frac{{P}_{x} ( {q}_{1} )}{{P}_{y} ( {q}_{1} )} = 1.603567451 .$$

The tangent line slope of the cost function curve at the market state q=(x, y) is

$$\frac{\partial y}{\partial x} = - \frac{{P}_{x} ( q )}{{P}_{y} ( q )} = - \frac{x - 6000}{y - 6000} .$$

This tangent line slope function (plot 570 of FIG. 5) changes very smoothly and stays in the interval [−1.603567451, −0.6236095645]. Thus the token price fluctuation is quite smooth. Furthermore, this cost function has a convex curve which conforms to the principle of supply and demand. That is, token price increases when token supply decreases. For constant circle cost function market, the sum of prices are bounded by Pₓ(q)+P_{y}(q)=2(x+y)−4a. Similar bounds hold for constant ellipse cost function market. Thus, when it is used for prediction market, there is a limit on the profit that a market maker can derive from transacting with traders.

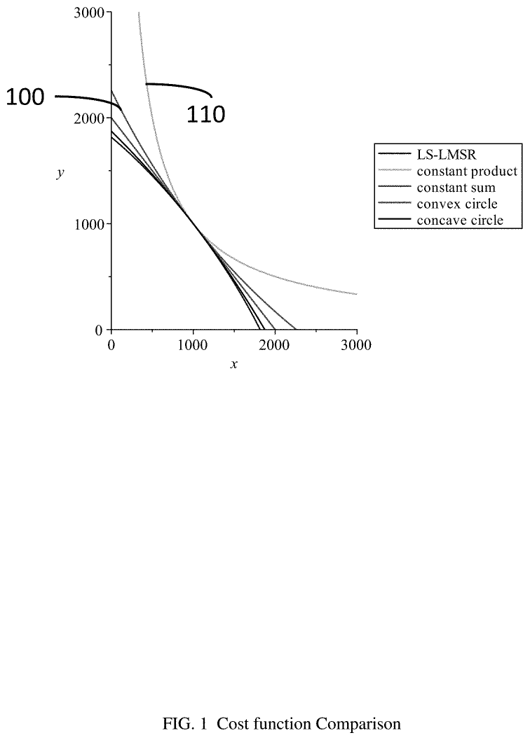

FIG. 1 compares the cost function curves for different AMMs that we have discussed. These curves shows that constant circle/ellipse cost function is among the best ones for DeFi applications. These curves are for cost functions (from bottom up):

$$( x + y ) ln ( {e}^{\frac{x}{x + y}} + {e}^{\frac{y}{x + y}} ) = 2000 \cdot$$

ln (2e^{1/2}), (x+6000)²+(y+6000)²=2×7000², x+y=2000, (x−6000)²+(y−6000)²=2×5000², and xy=1000000. Specifically, 100 is the curve of constant convex circle and 110 is the curve of constant product.

Front running attacks based on slippage have been well known for AMMs. In the following, we compare this attack against a constant product AMM and a constant circle AMM with an identical initial market state q₀=(1000, 1000) and a front running attacker with a budget of 200 USD.
1. For a constant product market maker, assume that Alice submits 50 coins of USDT to purchase coins of spade suit token in q₀. The front-running (e.g., a miner) intercepts this request and uses 200 coins of USDT token to get 166.6666667 coins of spade suit token leaving the market state at q₁=(1200, 833.3333333). The front-runner submits Alice's order to the market q₁ which returns 33.3333333 coins of spade suit token to Alice with a resulting market state q₂=(1250, 800). Now the front-runner uses 152.3809524 coins of spade suit token to get 200 USDT coins from q₂ with a resulting state q₃=(1050, 952.3809524). Through this process, the front-runner obtained 166.6666667−152.3809524=14.2857143 coins of spade suit token for free.
2. For a constant circle market maker with cost function C (q)=(x−6000)²+(y−6000)², assume that Alice submits 50 coins of USDT to purchase coins of spade suit token. The front-runner intercepts this request and uses 200 coins of USDT token to get 192.301994 coins of spade suit token leaving the market state at q₁=(1200, 807.698006). The front-runner submits Alice's order to the market q₁ which returns 45.779716 coins of spade suit token to Alice with a resulting market state q₂=(1250, 761.918290). Now the front-runner uses 188.576785 coins of spade suit token to get 200 USDT coins from q₂ with a resulting state q₃=(1050, 950.495075). Through this process, the front-runner obtained 192.301994-188.576785=3.725209 coins of spade suit token for free.
   These examples show that if front-runner's budget is 200 USDT, then the front-runner could make 3.725209 spade suit coins of profit in constant circle market and 14.2857143 spade suit coins of profit in constant product market.

Slippage based front-running attacks can always be launched if the tangent line slope for the cost function curve is not a constant. The more the tangent line slope fluctuates around the current market state, the more profit the front-runner can make. The analysis in preceding sections show that tangent line slopes for LS-LMSR and constant circle/ellipse cost functions fluctuate smoothly and tangent line slopes for constant product/mean cost functions fluctuate sharply. Thus LS-LMSR and constant circle/ellipse cost function automated markets are more robust against front running attacks than Uniswap and LMSR. In Uniswap V2, when a trader submits a transaction buying coins of token A with coins of token B (or vice versa), the trader may submit the order at the limit.

For constant product/mean AMMs, the relative price

$$\frac{{P}_{1} ( q )}{{P}_{2} ( q )}$$

of the two tokens ranges from 0 (not inclusive) to ∞. At the time when a tiny portion of one token coin is equivalent to all coins of the other token in the market maker, no trade is essentially fea-sible. Thus the claimed advantage that no one can take out all shares of one token from the constant product/mean market seems to have limited value. For a given LS-LMSR (or constant circle/ellipse) automated market with an initial state q₀, the relative price P₁(q)/P₂ (q) can take values only from a fixed interval. If the market changes and this relative price interval no long reflects the market price of the two tokens, one may need to add tokens to the market to adjust this price interval. On the other hand, it may be more efficient to just cancel this automated market maker and create a new AMM when this situation happens.

In the following example, we show how to add liquidity to an existing LS-LMSR AMM to adjust the relative price range. Assume that the market price for a coin of token A is 100 times the price for a coin of token B when the AMM is incorporated. The patron uses 10 coins of token A and 1000 coins of token B to create an AMM with the initial state q₀=(1000, 1000). The total market cost is C(q₀)=2386.294362. Assume that after some time, the AMM moves to state q₁=(100, 1750.618429). At q₁, we have P₁ (q₁)/P₂(q₁)=0.6809820540 which is close to the lowest possible value 0.6481149479. In order to adjust the AMM so that it still works when the value P₁/P₂ in the real world goes below 0.6481149479, the patron can add some coins of token A to q₁ so that the resulting market state is q₂=(1750.618429, 1750.618429). To guarantee that one coin of token B is equivalent to

$$\frac{{P}_{2} ( {q}_{1} )}{100 \cdot {P}_{1} ( {q}_{1} )} = 0.01468467479$$

coins or token A in q₂, we need to have the following mapping from outstanding shares in q₂ to actual token coins (note that this mapping is different from that for q₀):
Each outstanding share of token A corresponds to 0.01468467479 coin of token A.
Each outstanding share of token B corresponds to one coin of token B.

Thus there are 1750.618429×0.01468467479=25.70726231 coins of token A in q₂. Since there are only one coin of token A in q₁, the patron needs to deposit 24.70726231 coins of token A to q₁ to move the AMM to state q₂. If the market owner chooses not to deposit these tokens to the market, the market maker will still run, but there is a chance that the outstanding shares of token A goes to zero at certain time.

In the above scenario, one may ask whether it is possible for the market maker to automatically adjust the market state to q₃=(1750.618429, 1750.618429) by re-assigning the mapping from shares to coins? If q₂ automatically adjusts itself to q₃ without external liquidity input, then a trader may use one share of token A to get one share of token B in q₃. Since we only have one equivalent coin of token A but 1750.618429 outstanding shares in q₃, each outstanding share of token A in q₃ is equivalent to 0.0005712267068 coins of token A. That is, the trader used 0.0005712267068 coins of token A to get one coin of token B (note that each outstanding share of token B corresponds to one coin of token B in q₃). By our analysis in the preceding paragraphs, at q₃, one coin of token B has the same market value of 0.01468467479 coins of token A. In other words, the trader used 0.0005712267068 coins of token A to get equivalent 0.01468467479 coins of token A. Thus it is impossible for the automated market to adjust its relative price range without an external liquidity input.

We have implemented the constant ellipse based AMMs using Solidity smart contracts and have deployed them over Ethereum blockchain. The smart contract source codes and Web User Interface are available at GitHub. As an example, we use the circle (x−c)²+(y−c)²=r² to show how to establish a token pair swapping market in this section. Specifically, we use c=10⁹ and r·10¹⁴=16000·10¹⁴ (that is, r=16000) for illustration purpose in this section.

Each token pair market maintains constants λ₀ and λ₁ which are determined at the birth of the market. Furthermore, each token market also maintains a non-negative multiplicative scaling variable μ which is the minimal value so that the following equation holds.

(μλ₀x₀−10⁹)²+(μλ₁y₀−10⁹)²≤16000·10¹⁴ (9)

where μλ₀x₀−10⁹ and μλ₀y₀<10⁹. This ensures that we use the lower-left section of the circle for the automated market. The tangent line's slope at the point (x, y) for the pool circle is

$$\frac{\partial ( {λ}_{1} y )}{\partial ( {λ}_{0} x )} = - \frac{1 {0}^{9} - μ {λ}_{0} x}{1 {0}^{9} - μ {λ}_{1} y}$$

Thus for the reserves (x₀, y₀), the (λ₀,λ₁)-weighted relative price of the tokens at this market is

$${P}_{y / x} ( {x}_{0} , {y}_{0} ) = \frac{{λ}_{0} ( 1 {0}^{9} - μ {λ}_{0} {x}_{0} )}{{λ}_{1} ( 1 {0}^{9} - μ {λ}_{1} {y}_{0} )} . \qquad ( 10 )$$

That is, at market (x₀, y₀), Δₓ token A coins could be swapped for Δ_{y}=ΔₓP_{y/x}(x₀,y₀) token B coins.

Each market also maintains a non-negative multiplicative scaling variable μ and a total liquidity supply amount variable Ω. The value of Ω changes each time when a liquidity provider adds liquidity to or removes liquidity from the market. The liquidity value Ω should be defined in such a way that the following conditions are satisfied. Assume that the current market state is q=(x, y) with a market liquidity value Ω_{q}. If a customer moves the current market state to a new state q′=(e·x, e·y), then the new market liquidity value is Ω_{q′}l=e·Ω_{q}. This could be achieved in several ways. For example, Uniswap defines Ω(x, y)=\sqrt{xy}. In this section, we use the following approach. Let π(x, y)=ax+by for some constants a, b. For a given market state q=(x, y) with liquidity value Ω, if one moves the market state from q=(x, y) to q′=(e·x, e·y), then the mew market liquidity for q′ is defined in such a way that

$$\frac{{Ω}^{′}}{Ω} = \frac{π ( e \cdot x , e \cdot y )}{π ( x , y )} = e . \qquad ( 11 )$$

The reader should be aware of the fact that when the market moves on, we normally do not have Ω(x, y)=π(x, y). It should also be noted that an alternative function π(X, y)=\sqrt{x²+y²} could also be used in the equation (11) for certain applications.

Though in several other DEX applications (such as Uniswap V2), a liquidity provider normally provides equivalent values of token A and token B to the market each time, this is generally not true for our market makers. As an example, assume that the current market state is q=(x₀, y₀) with a total supply Ω. A liquidity provider can add some liquidity (δx₀, δy₀) for some δ>0 to the market without changing the current (λ₀, λ₁)-weighted relative price δ=P_{y/x}(x₀, y₀) in (10). That is, we need to keep

$$- {P}_{y / x} ( ( 1 + δ ) {x}_{0} , ( 1 + δ ) {y}_{0} ) = \frac{1 {0}^{9} - {μ}^{′} {λ}_{0} ( 1 + δ ) {x}_{0}}{1 {0}^{9} - {μ}^{′} {λ}_{1} ( 1 + δ ) {y}_{0}} = \frac{1 {0}^{9} - μ {λ}_{0} {x}_{0}}{1 {0}^{9} - μ {λ}_{1} {y}_{0}} \qquad ( 12 )$$

where x=x₀+Δₓ, y=y₀+Δ_{y}, and μ′>μ. It is straightforward to show that

$${μ}^{′} = \frac{μ}{1 + δ} .$$

As an example, assume that when the market is set up, one token A's value is equivalent to three token B's price. That is, we set λ₀=3 and λ₁=1. Now assume at some time with market (x₀, y₀), one token A's value is equivalent to two token B's price. That is,

$$\frac{\partial ( {λ}_{1} y )}{\partial ( {λ}_{0} x )} = - \frac{1 {0}^{9} - 3 μ {x}_{0}}{1 {0}^{9} - μ {y}_{0}} = - \frac{2}{3}$$

which means

$${y}_{0} = 4.5 {x}_{0} - \frac{1 {0}^{9}}{2 μ} .$$

A liquidity provider can select a δ>0 and add (δx₀, δy₀) tokens to the market. Generally we do not have δx₀=2δy₀ since

$${y}_{0} = 4.5 {x}_{0} - \frac{1 {0}^{9}}{2 μ}$$

does not guarantee x₀=2y₀.

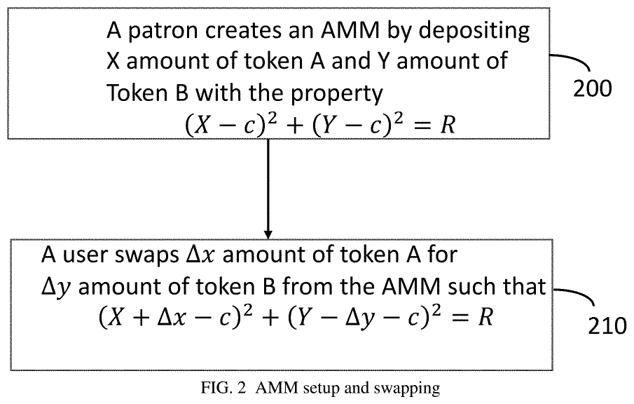

FIG. 2 shows the process of establishing a token pair market via 200 and a user carries out a swapping operation via 210. When a token pair market is not established yet, a liquidity provider can establish the token pair market by depositing x₀ coins of token A and y₀ coins of token B. The assumption is that the market value of x₀ coins of token A is equivalent to the market value of y₀ coins of token B. The token pair constant variables λ₀, λ₁ are defined as λ₀x₀˜λ₁y₀. Note that λ₀, λ₁ are extensively used by the swapping algorithm. Thus it is better to have simple/smaller λ₀, λ₁. This could be calculated by the smart contract using continuous fraction. It is recommended that the liquidity providers should provide the values of λ₀, λ₁ when establishing a new market (or by vote from the community). Let μ be the non-negative number such that the equation (9) holds. Let the liquidity of the token pair market be defined as

$${Ω}_{0} = {10}^{18} \cdot \frac{{λ}_{0} {x}_{0} + {λ}_{1} {y}_{0}}{2} .$$

As a return, the liquidity provider receives Ω₀ liquidity coins for this token pair market. In our implementation, it is required that each liquidity provider should put at least one coin for each token in the market. That is, for an ERC token with 10¹⁸ decimals, the liquidity provider should put at least 10¹⁸ units of token A and 10¹⁸ units of token B. This requirement insures that μ≤10⁹.

Data representations: We have the following conventions:
x, y are represented as uint96 though the right-most 18 digits are considered as decimals. With 18 decimal ERC20 tokens, the liquidity could contain 79 billion coins of each token which are sufficient for most tokens.
Liquidity value Ω: this is the inherited value totalSupply from the ERC20 and is of type uint256.
rSquare is of type uint16 and takes a valid value from 1 to 9999. Note that r²=(10000+rSquare)·10¹⁴. That is, we can select the price fluctuation from [0.01, 0.9999499985]. In this paper, we use rSquare=6000 as an example. That is, r²=16000·10′ and the weighted price fluctuation range of the underlying tokens is between 0.7745966692 and 1.290994449.
λ₀, λᵢ are of type uint16 and take values smaller than 65535.
In order to support tokens with smaller decimals (less than 18), we store D₀=10^{18-d}^{₀} and D₁=10^{18-d}^{₁} where d₀, d₀≤18 are decimals of the two tokens respectively. We use 56-bits to store D₀ and 56-bits to store D₁.
μ is of type uint56 where the right-most 7 digits are fractional part. That is, μ≤7205759403.7927936
   As a summary, a 224-bits variable is used to store these parameters related to the circle as follows

| | | | | | | |
|---|---|---|---|---|---|---|
| ICO(8) | D₀ (56) | D₁ (56) | r (16) | λ₀ (16) | λ₁ (16) | μ (56) |

In our implementation, the function getReservesAndmu returns the value D₀λ₀μ∥D₁λ₁μ in a 256-bit variable. That is, each Dᵢλᵢμ takes 128-bits. It is noted that λ is 16-bits, μ is 56-bits. Thus, to avoid overflow, it is required that Dᵢ<2⁵⁶=72057594037927936. In other words, we have 18−dᵢ≤16 and the underlying tokens must have at least two decimals.

Remarks: It is required that μΔx<10⁹ and μ has at most 7 fractional digits. Thus we need to have λx<10¹⁶. Furthermore, the maximal value for λ is 2¹⁶−1. If μ takes the minimal value and λ takes the maximal value 2¹⁶, then we have

$$x < \frac{1 {0}^{16}}{{2}^{16}} = {5}^{16} = 152587890625 .$$

Since the supposed maximal value for x is 79228162514, no overflow should happen if we require the balances for each token is represented by a 96-bit number with 18 decimals.

After the market is set up, the values of λ₀, λ₁ are fixed for the duration of the market. During the computation, we need to compute μλ₀x, (μλ₀x−10⁹)², μλ₁y, and (μλ₁y−10⁹)². Since we require μλ₀x<10⁹ and μλ₁y<10⁹. This means that each of μλ₀x and μλ₁y can be represented by a 25+9=34 digits (including decimals). That is, μλ₀x and μλ₁y can be represented by 113-bit binary strings (note that 25 decimal parts can be represented with a 83-bits binary string and 10⁹ can be represented with a 30-bits binary string). Thus the values (μλ₀x−10⁹)² and (μλ₁y−10⁹)² could be held in a 256-bit binary string.

Since it is challenging to support float computation in Solidity, for easy calculation of (9), we can multiply both sides of the equation by 10³⁶ so that x, y can then be treated as uint256. That is,

(μλ₀x₀·10¹⁸−10²⁷)²+(μλ₁y₀·10¹⁸−10²⁷)²=16000·10⁵⁰

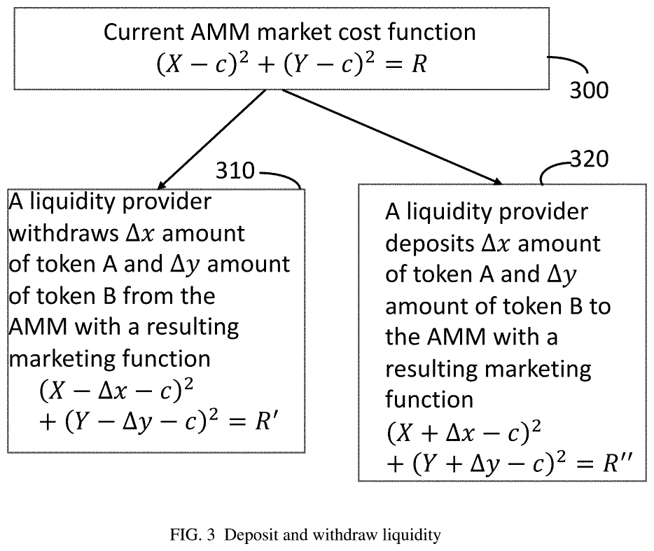

FIG. 3 shows the process 310 of depositing liquidity to an existing market and the process 320 of withdrawing liquidity from an existing market. Assuming that the current market status is q₀=(x₀, y₀) and the total supply of the token pair market is Ω₀. If a liquidity provider would like to add Δₓ token A coins to the market, then she/he also needs to add

$${Δ}_{y} = \frac{{Δ}_{x} {y}_{0}}{{x}_{0}}$$

token B coins to the market. The new total supply of the token pair market becomes

$${Ω}_{1} = \frac{{Ω}_{0} ( {λ}_{0} {x}_{1} + {λ}_{1} {y}_{1} )}{{λ}_{0} {x}_{0} + {λ}_{1} {y}_{0}}$$

where x₁=x₀+Δₓ and y₁=y₀+Δ₀. As a return, the liquidity provider will receive Ω₁−Ω₀ liquidity coins for this token pair market. The variable μ is adjusted in such a way that the following equation holds

(μλ₀x₁−10⁹)²+(μλ₁y₁−10⁹)²=16000·10¹⁴ (13)

with μλ₀x₁<10⁹ and μλ₁y₁<10⁹.

The minted liquidity and the adjusted μ could be computed alternatively as follows. Assume that x₀≈0. Then we have μ₀λ₀x₀=μλ₀x₁. That is,

$$μ = \frac{{μ}_{0} {x}_{0}}{{x}_{1}} and {Ω}_{1} = \frac{{Ω}_{0} {x}_{1}}{{x}_{0}} .$$

Removing liquidity. Assuming that the current market status is q₀=(x₀, y₀) and the total supply of the token pair market is Ω₀. If a liquidity provider would like to convert Δ_{Q} liquidity coins back to native coins, the liquidity provider will receive (Δₓ, Δ_{y}) tokens where

$${Δ}_{x} = \frac{{Δ}_{Ω} {x}_{0}}{{Ω}_{0}} and {Δ}_{y} = \frac{{y}_{0} {Δ}_{Ω}}{{Ω}_{0}} .$$

The new total supply of the token pair market becomes Ω=Ω₀−Δ_{Ω}. The multiplicative scaling variable μ is adjusted in such a way the equation (13) holds for x₁=x₀−Δₓ and y₁=y₀−Δ_{y} with μλ₀x₁<10⁹ and x₁=x₀−Δₓ and y₁=y₀−Δ_{y}<10⁹.

Swapping. Assuming that the current market status is q₀=(x₀, y₀) and the multiplicative scaling variable is μ. For each transactions, the customer should pay 0.3% transaction fee. Thus if a customer submits Δₓ token A coins to the market, the customer receives Δ_{y} token B coins such that

(μλ₀(x₀+0.997Δₓ)−10⁹)²+(λλ₁(y₀−Δ_{y})−10⁹)^{2≤(μλ}₀x₀−10⁹)²+(μλ₁y₀−10⁹)² (14)

where μλ₀(x₀+0.997Δₓ)<10⁹. Note that equation (14) is equivalent to the following equation.

(10²⁵μλ₀(10³·x₀+997Δₓ)−10³⁷)²+(10²⁸μλ₁y₀−10³⁷)² (15)

where we try to convert the fractional parts of μ and x₀, y₀ into integer parts. That is, μ has 7 fractional digits and x₀, y₀ have 18 fractional digits. In order to compute the value Δ_{y} using the equation (15), let

r₀=(10²⁸μλ₀x₀−10³⁷)²+(10²⁸μλ₁y₀−10³⁷)²−(10²⁵μλ₀(1000·x₀+997Δₓ)−10³⁷)².

Then we need to have

10³⁷−10²⁸μλ₁(y₀−Δ_{y})≤\sqrt{r₀}.

$$1 {0}^{18} {Δ}_{y} \leq \frac{1 {0}^{28} μ {λ}_{1} {y}_{0} + \sqrt{{r}_{0}} - 1 {0}^{37}}{1 {0}^{3} \cdot ( {10}^{7} μ ) {λ}_{1}} .$$

By the discussion in the preceding paragraphs, 10²⁵μλ₀x₀ and 10²⁵μλ₁y₀ could be represented using 113-bit binary strings. Thus 10²⁸μλ₀x₀ and 10²⁸μλ₁y₀ could be represented using 123-bit binary strings. On the other hand, 10³⁷ could also be represented by a 123-bit binary string. In a summary, r₀ could be represented by a 247-bit binary string. Thus in order to get 10¹⁸ fractional digit accuracy for Δ_{y}, it is sufficient for \sqrt{r₀} to have accuracy until the decimal point.

Given Δ_{y}, in order to compute Δₓ, we have the following formula:

r₁=(10²⁸μλ₀x₀−10³⁷)²+(10²⁸μλ₁x₀−10³⁷)²−(10²⁸μλ₁(y₀−Δ_{y})−10³⁷)².

Then we need to have

10³⁷−10²⁵μλ₀(10³x₀+997Δₓ)≤\sqrt{r₁}.

### That is,

$$1 {0}^{18} \cdot {Δ}_{x} \geq \frac{1 {0}^{37} - \sqrt{{r}_{1}} - 1 {0}^{28} μ {λ}_{0} {x}_{0}}{997 \cdot ( {10}^{7} μ ) {λ}_{0}} .$$

Similar analysis as in the preceding paragraphs shows that, r₁ has at most 247-bits and, in order to get 10¹⁸ fractional digit accuracy for Δₓ, it is sufficient for \sqrt{r₁} to have accuracy until the decimal point.

For each transaction, traders pay 0.30% fees on all traders. The system collects 0.05% protocol fee (included in the 0.30% transaction fee) when protocol fee is turned on. If this protocol fee is collected each time when a transaction is done, it would cost too much gas fee. Thus we adopt the mechanism that was taken by Uniswap that this fee is only calculated when liquidity is deposited or withdrawn or if a command for calculating protocol fee is received. Assume that the current market state is (x₀, y₀), the total liquidity supply amount is Ω, and the current multiplicative scaling variable is μ₀. Let μ be the number such that equation (9) holds with μλ₀x₀<10⁹ and μλ₀y₀<10⁹. By equation (9), the accumulated transaction fees are

$$\frac{{μ}_{0} {x}_{0} - μ {x}_{0}}{{μ}_{0}}$$

coins of token A and

$$\frac{{μ}_{0} {y}_{0} - μ {y}_{0}}{{μ}_{0}}$$

coins of token B. Thus we need to calculate the accumulated protocol fee Δ_{Ω} such that

$$\frac{{Δ}_{Ω}}{Ω + {Δ}_{Ω}} = \frac{1}{6} \frac{\frac{( {μ}_{0} - μ ) {λ}_{0} {x}_{0}}{{μ}_{0}} + \frac{( {μ}_{0} - μ ) {λ}_{1} {y}_{0}}{{μ}_{0}}}{{λ}_{0} {x}_{0} + {λ}_{1} {y}_{0}} = \frac{{μ}_{0} - μ}{6 {μ}_{0}} .$$

### That is,

$${Δ}_{Ω} = \frac{Ω ( {μ}_{0} - μ )}{5 {μ}_{0} + μ} . \qquad ( 16 )$$

Transfer the liquidity amount Δ_{Ω} to the given protocol fee address and increase the total supply liquidity to Ω+Δ_{Ω}. The new multiplicative scaling variable becomes μ.

The boundary price for the circle based automated market is reached when the balance of one token becomes zero. Assume that the cost function is r·10¹⁴=(x−10⁹)²+(y−10⁹)² and x=0. Then the price of the first token reaches the highest value of

$$\frac{\partial y}{\partial x} = \frac{1 {0}^{9}}{\sqrt{r \cdot {10}^{14} - 1 {0}^{18}}} = \frac{100}{\sqrt{r - 1000}}$$

The token price fluctuation could be adjusted by revising the value of the circle radius. The following table shows some examples.

| value r | minimal price | maximum price |
|---|---|---|
| 10001 | 0.01000000000 | 100.0000000 |
| 10010 | 0.03162277660 | 31.62277660 |
| 10100 | 0.1000000000 | 10.00000000 |
| 10500 | 0.2236067977 | 4.472135956 |
| 11000 | 0.3162277660 | 3.162277660 |
| 15000 | 0.7071067814 | 1.414213562 |
| 17000 | 0.8366600265 | 1.195228609 |
| 19000 | 0.9486832980 | 1.054092553 |
| 19900 | 0.9949874374 | 1.005037815 |
| 19990 | 0.9994998752 | 1.000500375 |
| 19999 | 0.9999499985 | 1.000050004 |

The implementation employs the cumulative price mechanism for price oracle services and the smart contract records the cumulative price ratio P_{y/x} of the equation (10). Let t₀, t₁, . . . , tₘ be the price checkpoints where the corresponding reserves are (x₀, y₀), . . . , (xₘ, yₘ). Then the smart contract records cumulative prices at time tₘ as the time-and-(λ₀,λ₁)-weighted average of the prices at these checkpoint times:

$${p}_{m} = {\sum }_{i = 1}^{m} \frac{{Δ}_{i} {λ}_{0} ( 1 {0}^{9} - μ {λ}_{0} {x}_{i} )}{{λ}_{1} ( 1 {0}^{9} - μ {λ}_{1} {y}_{i} )} \qquad ( 17 )$$

where Δᵢ=tᵢ−tᵢ₋₁. The (λ₀, λ₁)-weighted price for the time period [tₘ_{₁}, tₘ_{₂}] is then computed as

$${p}_{{m}_{1} , {m}_{2}} = {\sum }_{i = {m}_{1} + 1}^{{m}_{2}} \frac{{Δ}_{i} {λ}_{0} ( 1 {0}^{9} - μ {λ}_{0} {x}_{i} )}{{Δ}_{{m}_{1} , {m}_{2}} {λ}_{1} ( 1 {0}^{9} - μ {λ}_{1} {y}_{i} )} \qquad ( 18 )$$

where Δₘ_{₁}_{,m}_{₂}=tₘ_{₂}−tₘ_{₁}.

In the algorithms of preceding paragraphs, given (x₀, y₀), one needs to find the multiplicative scaling variable μ such that the equation (9) holds. For the circle

(μλ₀x₀·10²⁵−10³⁴)²+(μλ₁y₀·10²⁵−10³⁴)²=r·10⁶⁴ (19)

and a point (x₀, y₀) with x₀+y₀≠0, the value of μ is computed as follows. First the equation (19) can be converted to the following equation

10³⁶(x₀²λ₀²+y₀²λ₁²)(10⁷μ)²−2·10⁵²·(x₀λ₀+y₀λ₁(10⁷μ)+2·10⁶⁸−r·10⁶⁴=0.

That is, 10⁷·μ can be computed using the following equation (20).

$$⌈ 1 {0}^{32} \cdot \frac{{10}^{20} ( {x}_{0} {λ}_{0} + {y}_{0} {λ}_{1} ) \pm \sqrt{Γ}}{{10}^{36} ( {x}_{0}^{2} {λ}_{0}^{2} + {y}_{0}^{2} {λ}_{1}^{2} )} ⌉ . \qquad ( 20 )$$

where

Γ=10⁴⁰(x₀λ₀+y₀λ₁)²−10³⁶(20000−r)·(x₀²λ₀²+y₀²λ₁²)

For the two solutions in equation (20), one uses the μ such that μλ₀x₀<10⁹ and μλ₁y₀<10⁹. That is, λ₀x₀<10¹⁶ and λ₁y₀<10¹⁶. That is, the value inside \sqrt{·} has no fractional digits and is smaller than 10⁵⁺²⁽¹⁶⁺¹⁸⁾=10⁷³ which requires at most 245-bits. Since the denominator in (20) has at least 36 digits and there is a constant scale 10³² in the numerator, In order to keep all digits in 10⁷·μ significant, we need the square root to be approximated at least at O(10³). This is easily achieved using Newton's approach.

Calculation of λ₀ and λ₁: The values of λ₀ and λ₁ are determined by the liquidity that the user decides to put in. For example, if the user decides to put in x/10¹⁸ shares of token A and y/10¹⁸ shares of token B where the market values of these A tokens is equivalent to B tokens. The user interface should help the user to calculate λ₀ and λ₁ so that λ₀x˜λ₁y where λ₀, λ₁ are 16 bits. Without loss of generality, we may assume that x≥y. Let x=x₀x₁ . . . xₘ,xₘ₊₁ . . . and y=y₀y₁ . . . yₘ,yₘ₊₁ . . . are binary representations of x and y. It is noted that y₀ may be zero in some cases. The system should take λₓ=y₀ . . . y₁₆ and λ_{y}=x₀ . . . x₁₆.

Circle parameters: The default parameter for the circle is r²=16000×10¹⁴. In the smart contracts, a user needs to provide

circle=rSquare·2³²+λ₀·2¹⁶+λ₁

parameter for adding liquidity. For a pair of tokens A and B, the token with smaller address is defined as the token 0. However, these information should be transparent to the end users. Thus the system should compare the address of token A and token B. If token A address is less than token B, the system should set λ₀=λₓ. Otherwise, it should set λ₀=λ_{y}.

### REFERENCE CITED

Yongge Wang. Automated Market Makers for Decentralized Finance DeFi. US Provisional Patent application U. S. 63/073,890, filed on Sep. 2, 2020.
Steven Victor Wasserman. Blockchain digital currency: systems and methods for use in enterprise blockchain banking. U S patent US20180268382A1. 2018, Sep. 20
Masanobu Nishimaki. Server for supporting an exchange transaction. U S patent U.S. Pat. No. 8,671,043B2. 2014
Karl Ginter, et al. Method and system for negotiating electronic contract, method and system for supporting electronic commerce, and method and system for securely managing electronic negotiation electronic commerce values chain activity, method for managing distributed electronic commerce environment, and method and system for securely managing distributed electronic commerce environment. JP2004005629A, 2003.
Coinplug Co., Ltd. System and method for trading digital virtual money having blockchain between parties. WO2016163608A1, 2015-10-07.
Gnosis (2019). An exchange protocol for the decentralized web, September 2019. https://github.com/gnosis/dex-research/blob/master/dFusion/dfusion.v1.pdf.
I. J. Good (1952). Rational decisions. J. Royal Statistical Society B, 14(1):107-114, 1952.
R. Hanson (2003). Combinatorial information market design. Information Systems Frontiers, 5(1):107-119, 2003.
R. Hanson (2007). Logarithmic markets coring rules for modular combinatorial information aggregation. The Journal of Prediction Markets, 1(1):3-15, 2007.
F. Martinelli and N. Mushegian (2019). A non-custodial portfolio manager, liquidity provider, and price sensor. https://balancer.finance/whitepaper/, 2019.
A. Othman, D. M. Pennock, D. M. Reeves, and T. Sandholm (2013). A practical liquidity-sensitive automated market maker. ACM Tran. Economics and Computation (TEAC), 1(3):1-25, 2013.
J. Peterson and J. Krug (2015). Augur: a decentralized, open-source platform for prediction markets. arXiv preprint arXiv:1501.01042, 2015.
Uniswap V2 (2020). Uniswap v2 core, March 2020. https://uniswap.org/whitepaper.pdf.

What is claimed:

1. A method for providing Decentralized Finance (DeFi), the method comprising:
a) a computing platform executing a DeFi protocol, wherein the computing platform is acting as a digital property exchange center;
b) a first liquidity provider creating an automated market on the said digital property exchange center by depositing a first amount of a first digital property and a second amount of a second digital property in the said digital property exchange center;
c) a user swapping a third mount of the first digital property for a fourth amount of the second digital property from the said automated market.

2. The method of claim 1 wherein the first amount of the first digital property and the second amount of the second digital property are constraint by a cost function.

3. The method of claim 2 wherein the third amount of the first digital property and the fourth amount of the second digital property are constraint by the said cost function.

4. The method of claim 3 wherein the said cost function is an ellipse or a circle.

5. The method of claim 4 wherein the said ellipse is defined by an equation R=(q₁−a)²+(q₁−b)²+cq₁q₂ wherein R, a, b, c are market constants, q₁ is a first value of the first digital property, and q₂ is a second value of the second digital property.

6. The method of claim 2 wherein the first amount of the first digital property is a zero.

7. The method of claim 3 wherein the said cost function is defined by a mathematical curve.

8. The method of claim 7 wherein the mathematical curve allows the first digital property to take a value zero.
